(19) United States
(12) Patent Application Publication
(10) Pub. No.: US 2014/0107011 A1
(43) Pub. Date: Apr. 17, 2014

(54) COMPOSITIONS AND METHODS FOR CLEANING SURFACES

(71) Applicant: Commercial Pool, Inc., Maplewood, MN (US)

(72) Inventors: Tyler BANASZAK, Minneapolis, MN (US); Dakarai Kameron BROWN, St. Louis Park, MN (US)

(73) Assignee: Commercial Pool, Inc., Maplewood, MN (US)

(21) Appl. No.: 14/054,581

(22) Filed: Oct. 15, 2013

Related U.S. Application Data
(60) Provisional application No. 61/713,955, filed on Oct. 15, 2012.

(51) Int. Cl. C11D 3/37; C11D 3/34; C11D 3/22; C11D 3/20

(52) U.S. Cl. CPC C11D 3/3765; C11D 3/2082; C11D 3/3409; C11D 3/225
USPC 510/362; 510/476; 510/109; 510/470; 510/473

(57) ABSTRACT

The invention provides environmentally safe compositions and methods for cleaning surfaces to remove soap scum, iron oxide, calcium carbonate or calcium stearate deposits, or a combination thereof, from surfaces. The compositions of the invention comprise calcium chelating agents, one or more nonionic surfactants, one or more chelating agents, one or more anionic polymeric surfactants, an acid, and water, wherein the composition is alkaline. The compositions generally have a pH between 7.0 and 10, are biodegradable, non-toxic, free of VOCs, and are made of renewable, sustainable materials.

### BACKGROUND OF THE INVENTION

Many cleaning compositions are marketed for the purpose of cleaning a variety of surfaces and undesired particulates. Frequently, cleaning compositions are intended to remove iron stains, limescale and soap scum from surfaces.

Existing, commercially available compositions are frequently caustic and can cause skin irritation or burns in humans and animals. Other compositions are toxic to humans and animals. Others are environmentally unsafe or are not prepared from sustainable resources.

There is a continuing need for improved methods and compositions for providing outstanding cleaning performances on a variety of particulates and surfaces. Additionally, there is a continuing need to provide methods and compositions improving performance on the removal of soap scum, limescale and similar materials.

### SUMMARY OF THE INVENTION

The invention provides compositions for cleaning surfaces, comprising an effective amount of the following: one or more non-ionic surfactants, one or more nonionic surfactants, one or more polysaccharide polymers, water, and an alkaline material, wherein the pH of the composition is between about 7.0 and 10.

The compositions provided by the invention comprise one or more non-ionic surfactants. In an embodiment of the invention, the composition contains an itaconic acid polymer as a dispersant. In another embodiment of the invention, the composition contains Itaconix D2K as a dispersant. In a further embodiment of the invention, the dispersant in the composition comprises between about 0.05% to about 10% (w/w) of the composition.

The compositions provided by the invention comprise one or more non-ionic surfactants. In an embodiment of the invention, the composition contains an alkyl polyglucoside, alkyl polysaccharide, or an alkoxylated alcohol as a non-ionic surfactant. In another embodiment of the invention, the composition contains Jarfactant™ 225 as a non-ionic surfactant. In a further embodiment of the invention, the non-ionic surfactant in the composition of the invention comprises between about 0.05% to about 10% (w/w) of the composition.

The compositions provided by the invention comprise one or more polysaccharide polymers. In an embodiment of the invention, the composition contains carboxymethycellulose as a polysaccharide polymer. In a further embodiment of the invention, the polysaccharide polymer in the composition comprises between about 0.5% to about 20% (w/w) of the composition.

The compositions provided by the invention comprise one or more builders. In an embodiment of the invention, the composition contains sodium silicate as a builder. In a further embodiment of the invention, the builder in the composition comprises between about 0.01% to about 21% (w/w) of the composition.

In another embodiment of the invention, the compositions of the invention comprise one or more chelating agents. In an embodiment of the invention, the composition contains a polyamino carboxylic acid as a chelating agent. In a further embodiment of the invention, the chelating agent in the composition is nitrilotriacetic acid. In another embodiment of the invention, the chelating agent or agents comprise between about 0.01% to about 10% (w/w) of the composition.

In other embodiments of the invention, the compositions as described here may further comprise at least one selected from the group of a fragrance, a dye, a coloring agent, a biocide, a bactericide, an antifungal agent, a thickener, and a germicide. The compositions of the invention are biodegradable. In another embodiment of the invention, the compositions of the invention are created from sustainable and/or renewable reagents

In another embodiment of the invention, the compositions of the invention contain alkaline material. In certain embodiments of the invention, the alkaline material is sodium hydroxide. In other embodiments of the invention, the alkaline material is used to adjust the pH of the compositions to the proper range. In still other embodiments of the invention, the alkaline material used to adjust the pH of the compositions is 50% sodium hydroxide.

Also provided by the invention is a method of cleaning surfaces, comprising applying an amount of any of the compositions of the invention to a surface, where the top of the surface contains iron oxide, calcium carbonate or calcium stearate deposits, or a combination thereof, and wherein the application of the composition causes the iron oxide, calcium stearate, or calcium carbonate deposits, or the combination thereof, to disperse or dissolve. The amount of the compositions of the invention applied to the surface is an effective amount.

Additionally provided by the invention is a method of removing iron oxide, calcium carbonate or calcium stearate deposits from a surface, comprising applying an amount of any of the compositions of the invention to a surface, where the surface contains deposits of iron oxide, calcium carbonate or calcium stearate, or a combination thereof, and wherein the application of the composition causes the deposits of iron oxide, calcium stearate, or calcium carbonate, or the combination thereof, to disperse or dissolve.

Further provided by the invention is a method of soap scum from a surface, comprising applying an amount of any of the compositions of the invention to a surface, where the surface contains deposits of soap scum, and components of soap scum, including iron oxide, calcium carbonate or calcium stearate, or a combination thereof, and wherein the application of the composition causes the soap scum and components of soap scum to disperse or dissolve.

In one embodiment, the invention provides a composition for cleaning surfaces, comprising an effective amount of the following: one or more calcium chelating agents, one or more nonionic surfactants, one or more anionic polymeric surfactants, and water, wherein the pH of the composition is adjusted with an amount of an alkaline material to about 7.0 and 10.0. In the compositions provided herein, the calcium chelating agent is an itaconic acid polymer, such as Itaconix D2K. In the compositions, the calcium chelating agent comprises between about 0.05% to about 10% (w/w) of the composition.

In another embodiment, the composition of the invention comprises one nonionic surfactant, and the nonionic surfactant is an alkyl polyglucoside, alkyl polysaccharide, or an alkoxylated alcohol. Optionally, in the compositions, the nonionic surfactant is Jarfactant 225. In the compositions, the amount of nonionic surfactant comprises between about 0.05% to about 10% (w/w) of the composition.

Further, the compositions provided herein comprise one or more anionic polymeric surfactants. In certain embodiments, the anionic polymeric surfactant comprises between about 0.5% to about 20% (w/w) of the composition.

Optionally, the compositions comprise one or more chelating agents. In some embodiments, the composition comprises sodium gluconate as a chelating agent. In other embodiments, the amount of chelating agent comprises between about 0.01% to about 10.0% (w/w) of the composition.

According to certain embodiments, the alkaline material in the composition is sodium hydroxide.

Also, the compositions of the invention may further comprise at least one from the group comprising: a fragrance, a dye, an odor neutralizer, a coloring agent, a biocide, a bactericide, an antifungal agent, a thickener, and a germicide.

In some embodiments, the compositions provided herein are biodegradable. In other embodiments, the compositions are created from sustainable or renewable reagents. In other embodiments, the compositions of the invention are volatile organic carbon free. Other embodiments of the invention comprise compositions that are designed for the environment, or are designated by the Environmental Protection Agency of the United States Government as “DFE” (designed for the environment). In still other embodiments, the compositions comprise reagents that are volatile organic carbon free. In other embodiments, the compositions comprise reagents that are made from sustainable or renewable materials. In some embodiments, the compositions comprise reagents that are biodegradable.

A method of cleaning surfaces, comprising applying an effective amount of any of the composition of claims 1, to a surface, wherein the top of the surface contains iron oxide, calcium carbonate or calcium stearate deposits, or a combination thereof, and wherein the application of the composition causes the iron oxide, calcium stearate, or calcium carbonate deposits, or the combination thereof, to disperse or dissolve.

Also provided are compositions for cleaning surfaces, comprising an effective amount of the following: one or more calcium chelating agents, one or more nonionic surfactants, one or more chelating agents, one or more anionic polymeric surfactants, an acid, an odor neutralizer, a fragrance, and water, wherein the pH of the composition is adjusted with an amount of an alkaline material to about 7.0 and 10.0, wherein the composition is environmentally safe.

### BRIEF DESCRIPTION OF THE DRAWINGS

The following drawing forms part of the specification and is included to further demonstrate certain embodiments or various aspects of the invention. In some instances, embodiments of the invention can be best understood by referring to the accompanying drawing in combination with the detailed description presented herein. The description and accompanying drawing may highlight certain specific examples, or a certain aspect of the invention. However, one skilled in the art will understand that portions of the example or aspect may be used in combination with other examples or aspects of the invention.

FIG. 1: Graph of Turbidity in NTU as a function of amount of calcium stearate in Base Solution D. FIG. 1 illustrates turbidity values of 0.41, 10.16, and 71.1 from Base Solution D with the addition of 10, 50, and 100 mg of calcium stearate, respectively. When compared to results shown in Table 2, the additional 5 g of Sodium carboxymethyl cellulose had little effect on turbidity values obtained from calcium stearate. 50 mg of calcium carbonate resulted in 105.5 NTU, which is an increase from 70.9. Solution E was prepared to test the effect of sodium silicate as a builder. Results showed an exceptionally low turbidity (33.1 NTU) for calcium carbonate. When 0.8 grams of sodium silicate was added to Base Solution B the turbidity increased to 105.4 NTU. Solution E is the final formula.

### DETAILED DESCRIPTION OF THE INVENTION

Many commercially available compositions to clean hard surfaces show good overall cleaning performance and good limescale removal performance. For example WO 2004/018599 describes hard surface cleaning compositions comprising an acid or a mixture thereof. However, there are well known limitations to the acidic hard surface cleaners. Indeed, it is known that some hard surfaces, such as enamel and several metals, e.g. stainless steel and aluminum, are sensitive to acids and may be severely damaged by acidic compositions used to clean said surfaces. Additionally, some acid-based hard surface cleaner compositions show poor surface safety profiles.

The present invention provides a liquid surface cleaning composition that provides good limescale removal performance while showing a good surface safety profile on the treated surface. The compositions provided are suitable for use on hard surfaces and other surfaces.

The invention provides cleaning compositions for effective removal of limescale, iron deposits and/or soap scum from a wide variety of surfaces, including those that are frequently in contact with water or humidity. The compositions of the invention are effective for dissolving and/or removing iron oxide, calcium carbonate, and calcium stearate. The compositions of the invention have a pH value from about 7.0 to 10, and are safe to use on all surfaces. Unlike other cleaning compositions, the compositions of the invention are environmentally biodegradable, safe to use, free of VOCs (volatile organic carbon) and are prepared using sustainable resources.

### DEFINITIONS

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage. For example, one or more substituents on a phenyl ring refer to one to five, or one to four, for example if the phenyl ring is disubstituted.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percents, proximate to the recited range that are equivalent in terms of the functionality of the individual ingredient, the composition, or the embodiment.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

The term “contacting” refers to the act of touching, making contact, or of bringing to immediate or close proximity, including at the cellular or molecular level, for example, to bring about a reaction, a chemical reaction, or a physical change, e.g., in a solution, in a reaction mixture, on a surface.

An “effective amount” refers to an amount effective to bring about a desired or recited effect. For example, an amount effective can be an amount effective to reduce the growth of mold or bacteria on a household surface. Determination of an effective amount is well within the capacity of persons skilled in the art, especially in light of the detailed disclosure provided herein. The term “effective amount” is intended to include an amount of a compound described herein, or an amount of a combination of compounds described herein, e.g., that is effective to treat or prevent microbial or fungal growth on a household surface. Thus, an “effective amount” generally means an amount that provides the desired effect.

The terms “treating”, “treat” and “treatment” include (i) preventing the establishment or accumulation of one or more of iron oxide deposits, limescale deposits, calcium carbonate deposits, calcium stearate deposits, dirt, debris, soap scum, and/or bacterial or fungal growth on a household surface; (ii) inhibiting the establishment or accumulation of one or more of iron oxide deposits, limescale deposits, calcium carbonate deposits, calcium stearate deposits, dirt, debris, soap scum, and/or bacterial or fungal growth on a household surface; (iii) removing one or more of the iron oxide deposits, limescale deposits, calcium carbonate deposits, calcium stearate deposits, dirt, debris, soap scum, and/or bacterial or fungal growth on a household surface; and/or (iv) diminishing the establishment or accumulation of one or more of iron oxide deposits, limescale deposits, calcium carbonate deposits, calcium stearate deposits, dirt, debris, soap scum, bacterial or fungal growth on a household surface. Thus, the terms “treat”, “treatment”, and “treating” extend to and include prevention, preventing, lowering, stopping, removing or reversing the progression or accumulation of one or more of iron oxide deposits, limescale deposits, calcium carbonate deposits, calcium stearate deposits, dirt, debris, and/or soap scum, and/or bacterial or fungal growth on a household surface. As such, the term “treatment” includes both preventive and post-establishment administration, as appropriate.

The terms “inhibit”, “inhibiting”, and “inhibition” refer to the slowing, halting, or reversing the accumulation of dirt, debris, soap scum, or bacterial or fungal growth on a household surface, including but not limited to a surface frequently in direct contact with water, moisture or other liquids. The inhibition can be greater than about 20%, 40%, 60%, 80%, 90%, 95%, or 99%, for example, compared to the growth or progression that occurs in the absence of the treatment or contacting.

As used herein, “surfaces” or “hard surfaces” are used to describe materials such as glazed and non-glazed ceramic tiles, enamel, stainless steel, Formica, Fiberglass, vinyl, no-wax vinyl, linoleum, melamine, glass, plastics, Corian and other solid surfaces, and other surfaces used in environments where the surface is frequently in contact with water.

As used herein, “soap scum” is a general term that refers to a film or build-up on the surface of something, such as a hard surface, table, countertop, tile, or other area. In general, soap scum refers to the build-up on a surface of one or more of materials such as, but not limited to, soaps, materials found in soaps, fats, debris, dirt, limescale, rust, iron deposits, calcium stearate deposits, water deposits, calcium carbonate deposits, soap additives, and may even include bacteria, fungi, mold, or by-products or waste products thereof.

As used herein, the term “biodegradable” refers to the ability of a substance to be transformed into new compounds through biochemical reactions, decomposition, or the actions of biological agents, including but not limited to microorganisms such as bacteria.

As used herein, the terms “renewable” and “sustainable” refer to types of natural resource that can be replenished, renewed, or produced in a rather short amount of time to sustain the rate of consumption. Examples of renewable or sustainable resources include, but are not limited to, those derived from plants, including plant extracts, and plant by-products, essential oils, and those derived from fungi or microorganisms.

As used herein, the phrase “environmentally friendly” or “environmentally safe” is intended to mean not harmful to the environment, or not detrimental to the health and well-being of the environment.

As used herein, the term “non-toxic” is a term that refers to a substance that is not capable of causing damage to an organism.

As used herein, the term “hypoallergenic” refers to a substance that does not cause or is not likely to cause, allergic response or reaction in an animal, including a human.

### The Cleaning Compositions

The compositions according to the present invention are designed as surface cleaners. The compositions according to the present invention are liquid compositions (including gels) and pastes, as well as abrasive cleaner formulations, as opposed to gases.

In an embodiment, the liquid alkali hard surface cleaning compositions according to the present invention are aqueous compositions. Therefore, they may comprise from 70% to 99% by weight of the total composition of water, preferably from 75% to 95% and more preferably from 80% to 95%.

The compositions of the present invention are alkali and have a pH comprised of about 6 to 12, preferably about 6.5 to 11.5, preferably about 7.0 to 11, and also preferably about 7.5 to 10. The compositions of the invention can be used in all surfaces, because of the pH of the compositions.

The compositions herein comprise an alkaline material. An alkaline material may be present to adjust the pH and/or maintain the pH of the compositions according to the present invention. Examples of alkaline material are sodium hydroxide, potassium hydroxide and/or lithium hydroxide, and/or the alkali metal oxides such, as sodium and/or potassium oxide or mixtures thereof and/or monoethanolamine and/or triethanolamine. Other suitable bases include, as non-limiting examples, ammonia, ammonium carbonate, and choline base. Optionally, the source of alkalinity is sodium hydroxide, 50% (w/w) sodium hydroxide or potassium hydroxide.

In an embodiment, the amount of alkaline material is of from 0.0001% to 20% by weight of the composition, preferably from 0.0025% to 10% by weight of the composition and preferably from 0.001% to 5% by weight of the composition.

In an embodiment, the compositions herein have a water-like viscosity. As used herein, the phrase “water-like viscosity” refers to a viscosity that is close to or approximates the viscosity of water. In an embodiment, the liquid hard surface cleaning compositions herein have a viscosity of up to 50 cps at 60 rpm, more preferably from 0 cps to 30 cps, more preferably from 0 cps to 20 cps and more preferably from 0 cps to 10 cps at 60 rpm¹ and 20° C., when measured with a Brookfield digital viscometer model DV II, with spindle 2.

In another embodiment, the compositions are thickened compositions. Thus, in certain embodiments of the invention, the liquid hard surface cleaning compositions preferably have a viscosity of from 50 cps to 5000 cps at 20 s⁻¹, more preferably from 50 cps to 2000 cps, yet more preferably from 50 cps to 1000 cps and most preferably from 50 cps to 500 cps at 20 s⁻¹ and 20° C., when measured with a Rheometer, model AR 1000 (Supplied by TA Instruments) with a 4 cm conic spindle in stainless steel 2° angle (linear increment from 0.1 to 100 sec⁻¹ in max. 8 minutes). In other embodiments of the invention, the thickened compositions are shear-thinning compositions. The thickened liquid hard surface cleaning compositions herein optionally comprise a thickener.

### Chelating Agents

The compositions of the present invention optionally comprise a chelating agent or mixtures thereof. Multivalent cations are cations (positively charged metal complexes) with a charge greater than 1+. Usually, the cations have the charge of 2+. Common cations found in water, including hard water, include Ca²⁺ and Mg²⁺ metal ions. Other cations found in water include, for example, Cu²⁺ and Fe³⁺. Suitable chelating agents to be used herein include, but are not limited to, those that form coordination compounds (or chelates) with metal ions commonly found in water.

Examples of chelating agents that can be used in the compositions of the invention include, but are not limited to, polyamino carboxylic acids, methylglycine diacetic acid (MGDA), hydroxyethyl ethylene diaminetriacetic acid (HEEDTA), propanolamine, diethylenetriamine pentacetic acid (DTPA), nitrolotriacetic acid (NTA), alkali metal ethane 1-hydroxy diphosphonates (HEDP), alkylene poly(alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The chelating agents may be present either in their acid form or as salts of different cations on some or all of their acid functionalities, including but not limited to any conjugate base forms of the chelating agents.

On an embodiment of the invention, the chelating agent is a polyamino carboxylic acid. In another embodiment of the invention, the chelating agent is nitrilotriacetic acid (NTA), C₆H₉NO₆, which is an aminotricarboxylic acid. Synonyms for NTA include, but are not limited to, N,N-bis(carboxymethyl)glycine, 2-[bis(carboxymethyl)amino]acetic acid, triglycollamic acid (TGA), Trilone A, alpha,alpha′,alpha″-trimethylaminetricarboxylic acid, tri(carboxymethyl)amine, aminotriacetic acid, Hampshire NTA acid, nitrilo-2,2″,2″-triacetic acid, and Titriplex I. NTA, as used in the methods and compositions herein, is a chelating agent which forms coordination compounds with metal ions (chelates), such as Ca²⁺, Cu²⁺ or Fe³⁺.

In certain embodiments of the invention, the chelating agent is selected for its performance as a chelator and for other desirable properties, including but not limited to, biodegradability and biocompatibility.

Chelating agents can be incorporated in the compositions herein in amounts ranging from 0.001 to 15% by weight of the total composition, also preferably 0.01 to 10.0% by weight of the total composition, and also preferably 0.03 to 5% by weight of the total composition.

An amount of a chelating agent or a combination of chelating agents in the compositions described herein may range from about 0.001 to about 15.0% by weight of the total composition, preferably from about 0.01 to about 10% by weight of the total composition, preferably from 0.01% to about 10% by weight of the total composition, preferably from about 0.03 to about 5% by weight of the total composition, and preferably from about 0.04 to about 2% by weight of the composition, and preferably from about 0.05 to about 1.0% by weight of the composition.

Additionally, an amount of a chelating agent or a combination of chelating agents in the compositions described herein may range between about 0.001 to about 15.0% (w/w) of the composition, preferably between about 0.01 to about 10.0% (w/w) of the total composition, preferably between about 0.01% to about 10% (w/w) of the composition, preferably between about 0.03 to about 5% (w/w) of the composition, and preferably between about 0.04 to about 2% (w/w) of the composition, and preferably between about 0.05 to about 1.0% (w/w) of the composition.

The chelating agents used in the invention are commercially available from various chemical companies, including but not limited to J. T. Baker, SOLUTIA, and W.R. Grace/Durex.

### Nonionic Surfactant

The compositions of the present invention comprise one or more nonionic surfactants, or a mixture thereof. Nonionic surfactants may be desired as they further contribute to cleaning performance of the cleaning compositions of the invention. In some cases, it has been found that nonionic surfactants can contribute to the ability of the cleaning solution to achieve improved soap scum removal and greasy soap scum removal from surfaces. In the compositions provided herein, naturally derived surfactants may be used.

An amount of a non-ionic surfactant or combination of non-ionic surfactants in the compositions described herein may range from up to 25% by weight of the total composition, preferably from 0.1 to 20% by weight of the total composition, preferably from 0.05% to 15% by weight of the total composition, preferably from 0.2 to 10% by weight of the total composition, preferably from 0.5 to 7% by weight of the total composition, and also preferably from 0.75 to 3.5% by weight of the total composition.

Additionally, an amount of a non-ionic surfactant or combination of non-ionic surfactants in the compositions described herein may range from up to 25% (w/w) of the composition, preferably between about 0.1 to about 20% (w/w) of the composition, preferably between about 0.05% to about 15% (w/w) of the composition, preferably between about 0.2 to about 10% (w/w) of the composition, preferably between about 0.5 to about 7% (w/w) of the composition, and also preferably between about 0.75 to about 3.5% (w/w) of the composition.

Nonionic surfactants for use herein include, but are not limited to, alkyl polyglucosides, and alkoxylated alcohol nonionic surfactants, which can be readily made by condensation processes which are well-known in the art. A great variety of such alkoxylated alcohols, especially ethoxylated and/or propoxylated alcohols, are conveniently commercially available. Accordingly, alkoxylated alcohols for use herein include, but are not limited to, nonionic surfactants according to the formula RO (E) e (P) pH where R is a hydrocarbon chain of from 2 to 24 carbon atoms, E is ethylene oxide and P is propylene oxide, and e and p which represent the average degree of, respectively ethoxylation and propoxylation, are of from 0 to 24 (with the sum of e+p being at least 1). The hydrophobic moiety of the nonionic compound can be a primary or secondary, straight or branched alcohol having from 8 to 24 carbon atoms.

In certain embodiments of the invention, the nonionic surfactants for use in the compositions of the invention include, but are not limited to, alkyl polyglycosides (APGs), alkyl polysaccharides, decyl glucosides, APG0810, Octyldecyl Glucoside, decyl octyl D-glucose, alkyl(C₈-C₁₀)polyglycoside, decyl-octyl glycosides oligomer, (C₅-C₁₅)Alkyl ether of corn sugar, D-glucose, decyl octyl ethers, oligomeric, D-Glucopyranose, oligomeric, and decyl octyl glycosides.

The use of surfactants such as, but not limited to, alkylpolysaccharides in the invention is advantageous because they contain no toxic trace impurities, they are readily biodegradable, they are derived from renewable resources and they demonstrate very little tendency to skin irritation.

The condensation products of ethylene oxide and/or propylene oxide with alcohols having a straight or branched alkyl chain, having from 6 to 22 carbon atoms, wherein the degree of alkoxylation (ethoxylation and/or propoxylation) is from 1 to 15, preferably from 5 to 12. Such suitable nonionic surfactants are commercially available from for instance, JARCHEM (under the trade name Jarfactant™, including 225DK, 325, 425N, 600UP, L, L30, SLG, SLMT), USA and CarboSynth Limited, UK. Jarfactant™ including 225DK is one example of a naturally derived surfactant that is suitable for use in the compositions provided herein.

Additional surfactants or chelating agents may be used in the compositions of the invention. Natural surfactants or natural chelating agents can be used in certain embodiments of the compositions of the invention. As a non-limiting example, sodium gluconate can be used in the compositions provided herein.

### Dispersants or Calcium Chelating Agents

The compositions of the invention comprise one or more dispersants, dispersant supports, calcium binding agents, calcium chelating agents, or a mixture thereof. As used herein, the terms dispersants, dispersant supports, calcium binding agents and calcium chelating agents are interchangeable. The dispersants and calcium chelating agents suitable for use in the compositions of the invention include, but are not limited to, low molecular weight non-linear polyitaconic acids, partially neutralized with sodium salt. Non-limiting examples of dispersants or calcium chelating agents suitable for use in the compositions and cleaning solutions of the invention include POLY(ITACONIC ACID); itaconicacidpolymers; ITACONIC ACID POLYMER; itaconic acid homopolymer; poly(2-methylenesuccinicacid); methylenesuccinicacidpolymers; methylene-butanedioicacihomopolymer, 2-methylidenebutanedioic acid, Itaconix D2k low molecular weight linear polyitaconic acid C15H18O12X2, C₅H₆O4PIA. The dispersants or calcium chelating agents suitable for use in the compositions of the invention include water soluble dispersants, bio-based dispersants and biodegradable dispersants.

The compositions according to the present invention may comprise one or more dispersants or calcium chelating agents at an amount up to 25% by weight of the total composition, preferably from 0.1 to 20% by weight of the total composition, preferably from 0.2 to 15% by weight of the total composition, also preferably from 0.5 to 10% by weight of the total composition, and also preferably from 0.75 to 5.0% by weight of the total composition.

The compositions according to the present invention may comprise one or more dispersants or calcium chelating agents at an amount up to 25% (w/w) of the composition, preferably between about 0.1 to about 20% (w/w) of the composition, preferably between about 0.05 to about 15% (w/w) of the composition preferably between about 0.2 to about 15% (w/w) of the composition, also preferably between about 0.5 to about 10% (w/w) of the composition, and also preferably between about 0.75 to about 5.0% (w/w) of the composition.

Dispersants or calcium chelating agents are commonly commercially available from, for example, PolySciences, Inc., and Itaconix. As a non-limiting example, Itaconix is a corn-based calcium chelating agent that is suitable for use in the compositions provided herein.

### Builders

In an embodiment of the invention, sodium silicate can be used as a builder or a corrosion inhibitor. In certain embodiments of the invention, sodium silicate can protect metal components of machines or household areas, and to prevent iron deposits, calcium carbonate deposits, calcium stearate deposits, and deposits from soils, dirt, soap scum, and grease from redepositing on surfaces.

In an embodiment of the invention, one or more builders can bind cations (mainly calcium, Ca2+, and magnesium Mg2+) contained in cleaning solutions. In an embodiment of the invention, one of more builders can improve the quality of the water, and therefore, allow the other reagents in the compositions of the invention to work in a more efficient way. For example, one or more builders may soften water by binding free ions in water (magnesium, calcium). In some embodiments of the invention, more than one builder is used in the composition.

The amount of a builder or combination of builders in the compositions described herein may range from up to 10% by weight of the total composition, preferably from 0.001 to 8% by weight of the total composition, preferably from 0.01 to 6% by weight of the total composition, preferably from 0.5 to 5% by weight of the total composition, and also preferably from 0.3 to 3.5% by weight of the total composition.

Additionally, the amount of a builder or combination of builders in the compositions described herein may range from up to 10% (w/w) of the composition, preferably between about 0.001 to about 8% (w/w) of the composition, preferably between about 0.01 to about 6% (w/w) of the composition, preferably between about 0.5 to about 5% (w/w) of the composition, and also preferably between about 0.3 to about 3.5% (w/w) of the composition.

Sodium silicate, as used in an embodiment of the invention, is commercially available from various chemical companies, including but not limited to J. T. Baker.

### Polysaccharide Polymer

The compositions of the present invention may optionally comprise a polysaccharide polymer or a mixture thereof. Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like Xanthan gum, gellan gum, guar gum, locust bean gum, tragacanth gum or derivatives thereof, or mixtures thereof.

In an embodiment of the invention, the compositions comprise a polysaccharide polymer selected from the group consisting of: carboxymethylcellulose, ethyl cellulose, hydroxyethyl cellulose, hydroxypropyl cellulose, hydroxymethyl cellulose, succinoglycan gum, Xanthan gum, gellan gum, guar gum, locust bean gum, tragacanth gum, derivatives of the aforementioned, and mixtures thereof. Polysaccharide polymers are commercially available for instance from J. T. Baker.

The compositions according to the present invention may comprise one or more polysaccharide polymers at an amount up to 30% by weight of the total composition, preferably from 0.05 to 20% by weight of the total composition, preferably from 0.5 to 20% by weight of the total composition, preferably from about 0.5 to 20% by weight of the total composition, also preferably from 0.8 to 7% by weight of the total composition, and also preferably from 1.0 to 3.5% by weight of the total composition.

Additionally, the compositions according to the present invention may comprise one or more polysaccharide polymers at an amount up to 30% (w/w) of the composition, preferably between about 0.05 to about 20% (w/w) of the composition, preferably between about 0.5 to about 20% (w/w) of the composition, preferably between about 0.5 to about 20% (w/w) of the composition, also preferably between about 0.8 to about 7% (w/w) of the composition, and also preferably between about 1.0 to about 3.5% (w/w) of the composition.

It has surprisingly been found that the polysaccharide polymers or mixtures thereof herein act as surface modifying polymers (preferably combined with a vinylpyrrolidone homopolymer or copolymer, as described herein) and/or as thickening agents.

Indeed, the polysaccharide polymers or mixtures thereof herein can be used to thicken the compositions according to the present invention. It has been surprisingly found that the use of polysaccharide polymers or mixtures thereof herein provides excellent thickening performance to the compositions herein. Moreover, it has been found that the use of polysaccharide polymers or mixtures thereof herein, provides excellent thickening while not or only marginally reducing the limescale removal performance. Indeed, thickened compositions usually tend to show a drop in soil/stain removal performance (which in turn requires an increased level of actives to compensate for the performance drop) due to the thickening. It has been found that this is due to the fact that the actives providing the soil/stain removal performance are less free to migrate to the soil/stain. However, it has been surprisingly found that when polysaccharide polymers or mixtures thereof herein, are used as thickeners for the compositions herein, the drop in soil/stain removal performance is substantially reduced or even prevented.

Furthermore, without intended to be bound by theory, it has been shown that vinylpyrrolidone homopolymers or copolymers, preferably the vinylpyrrolidone homopolymer, and polysaccharide polymers described herein, when added into an aqueous composition deliver improved shine to the treated surface as well as improved next-time cleaning benefit on said surface, while delivering good first-time hard-surface cleaning performance and good limescale removal performance. Furthermore, the formation of iron deposits, calcium carbonate and calcium stearate deposits, watermarks, and soap scum and/or limescale deposits upon drying is reduced or even eliminated.

Moreover, the vinylpyrrolidone homopolymers or copolymers and polysaccharide polymers further provide long lasting protection against formation of iron deposits, calcium carbonate and calcium stearate deposits, watermarks, soap scum and/or deposition of limescale deposits, hence, long lasting clean surfaces.

A further benefit of the use of polysaccharide polymers, including carboxymethyl cellulose, is that many are non-toxic and hypoallergenic.

### Fragrance

The compositions and cleaning formulations of the invention optionally comprise a fragrance or a scent formulation. The fragrance or scent formulation can comprise one or more scent selected from any commercially available scent or fragrance, including but not limited to lime, lemon, orange, banana, blood orange, lavender, mint, cinnamon, clove, ginger, pine, or cedar. Commercially available fragrances suitable for use in the compositions and formulations of the invention include, but are not limited to, Ocean Mist, and the like.

### Wicking Agents

The compositions and cleaning formulations of the invention optionally comprise one or more wicking agents. The wicking agents suitable for the compositions and formulations include, but are not limited to, anionic polymeric surfactants, including those anionic polymeric surfactants that prevent streaks when applied to glass or other surfaces. As a non-limiting example, EGM from Videt International is a VOC-free or zero-VOC wicking agent that can be used in the compositions and formulations provided herein. Other VOC-free wicking agents may be used in the compositions and cleaning formulations of the invention.

### Odor Neutralizer

The compositions and cleaning formulations of the invention optionally comprise one or more agents for the purpose of neutralizing odors or counteracting the effect of odors. Suitable odor neutralizers for use in the compositions and formulations provided herein are those that are chemically compatible with the components of the compositions and formulations of the invention. In addition, suitable odor neutralizers for use in the compositions and formulations provided herein are those that are safe for the environment, or are designated “DFE” by the Environmental protection agency, and/or those that are compatible with current “Green” technology standard. In some embodiments, the odor neutralizer is water based and environmentally safe or friendly. As a non-limiting example of an odor neutralizer, BON (BioWorld Odor Neutralizer, BioWorld Products, USA) is an odor neutralizer that can be used in the compositions and formulations provided herein. Other odor neutralizers may be used in the compositions and cleaning formulations of the invention.

### Dyes or Coloring Agents

The liquid compositions according to the present invention may optionally be colored. Accordingly, they may comprise a dye or a mixture thereof. Suitable dyes for use herein are alkali stable dyes. By alkali-stable, it is meant herein a compound which is chemically and physically stable in the alkali environment of the compositions herein.

### Other or Optional Components

Other components which may be present in the compositions described herein may include but are not limited to pH adjustment agents, biocides, bactericides, sterilization agents, antifungal agents, germicides, thickeners, and the like.

Soaps and synthetic detergent cleansing agents frequently work well in soft water. In hard water, which contains a relatively high amount of calcium in solution, the calcium reacts with soap or detergent to form a gummy material called soap scum. Soap scum typically includes dirt and other matter. Any surface exposed to soap, water and dirt, oil or other material can accumulate soap scum. Soap scum is frequently seen in showers, bathtubs, laundry tubs, and sinks, as well as parts of appliances that are in contact with soap and water. Soap scum is what forms the familiar, unsightly ring in bathtubs and sinks.

Limescale deposits, calcium carbonate deposits, calcium stearate deposits and/or iron deposits are stains that frequently occur on surfaces found in many areas, including but not limited to bathrooms, toilets, garages, driveways, basements, gardens, and kitchens. These deposits can form on surfaces that are frequently exposed to or in contact with water. The formation of these deposits occurs when water containing solubilized ions evaporates, leaving behind salts such as calcium carbonate. The visible deposits result in an unaesthetic aspect of the surfaces. The formation and deposition phenomenon can occur on any surface, including those surfaces wherever water is, but most acutely in places where water is particularly hard. Furthermore, such deposits are prone to combination with other types of soils, such as soap scum or grease, and can lead to the formation of limescale-soil mixture deposits (limescale-containing soils). The removal of limescale deposits and limescale-containing soils is herein in general referred to as “limescale removal” or “removing limescale”.

The invention provides compositions for cleaning surfaces, comprising an effective amount of the following: one or more calcium chelating agents, one or more nonionic surfactants, one or more anionic polymeric surfactants, an acid, water, and an alkaline material, wherein the pH of the composition is between about 6.0 and 11, or between about 6.5 and 10, or between about 7.0 and 9.0.

The compositions provided by the invention comprise one or more non-ionic surfactants. In an embodiment of the invention, the composition contains an itaconic acid polymer as a dispersant. In another embodiment of the invention, the composition contains Itaconix D2K as a dispersant. In a further embodiment of the invention, the dispersant in the composition comprises between about 0.05% to about 15% (w/w) of the composition.

The compositions provided by the invention comprise one or more non-ionic surfactants. In an embodiment of the invention, the composition contains an alkyl polyglucoside, alkyl polysaccharide, or an alkoxylated alcohol as a non-ionic surfactant. In another embodiment of the invention, the composition contains Jarfactant 225 as a non-ionic surfactant. In a further embodiment of the invention, the non-ionic surfactant in the composition of the invention comprises between about 0.05% to about 15% (w/w) of the composition.

The compositions provided by the invention optionally comprise one or more polysaccharide polymers. In an embodiment of the invention, the composition contains carboxymethycellulose as a polysaccharide polymer. In a further embodiment of the invention, the polysaccharide polymer in the composition comprises between about 0.5% to about 25% (w/w) of the composition.

The compositions provided by the invention optionally comprise one or more builders. In an embodiment of the invention, the composition contains sodium silicate as a builder. In a further embodiment of the invention, the builder in the composition comprises between about 0.01% to about 30% (w/w) of the composition.

In another embodiment of the invention, the compositions of the invention comprise one or more chelating agents. In an embodiment of the invention, the composition contains a polyamino carboxylic acid as a chelating agent. In another embodiment of the invention, the chelating agent or agents comprise between about 0.01% to about 15% (w/w) of the composition.

In other embodiments of the invention, the compositions as described here may further comprise at least one selected from the group of a fragrance, a dye, an odor neutralizer, a coloring agent, a biocide, a bactericide, an antifungal agent, a thickener, a preservative and a germicide. The compositions of the invention are biodegradable. In another embodiment of the invention, the compositions of the invention are created from sustainable and/or renewable reagents.

In another embodiment of the invention, the compositions of the invention contain alkaline material. In certain embodiments of the invention, the alkaline material is sodium hydroxide. In other embodiments of the invention, the alkaline material is used to adjust the pH of the compositions to the proper range. In still other embodiments of the invention, the alkaline material used to adjust the pH of the compositions is 50% sodium hydroxide.

In another embodiment of the invention, the compositions and formulations contain acidic material. In certain embodiments of the invention, the acidic material is citric acid or other tribasic acids. In other embodiments of the invention, the acidic material is used to adjust the pH of the compositions and formulations to the proper range. Additionally, the acidic material is used as a preservative.

Also provided by the invention is a method of cleaning surfaces, comprising applying an amount of any of the compositions of the invention to a surface, where the top of the surface contains iron oxide, calcium carbonate or calcium stearate deposits, or a combination thereof, and wherein the application of the composition causes the iron oxide, calcium stearate, or calcium carbonate deposits, or the combination thereof, to disperse or dissolve. The amount of the compositions of the invention applied to the surface is an effective amount.

Additionally provided by the invention is a method of removing iron oxide, calcium carbonate or calcium stearate deposits from a surface, comprising applying an amount of any of the compositions of the invention to a surface, where the surface contains deposits of iron oxide, calcium carbonate or calcium stearate, or a combination thereof, and wherein the application of the composition causes the deposits of iron oxide, calcium stearate, or calcium carbonate, or the combination thereof, to disperse or dissolve.

Further provided by the invention is a method of soap scum from a surface, comprising applying an amount of any of the compositions of the invention to a surface, where the surface contains deposits of soap scum, and components of soap scum, including iron oxide, calcium carbonate or calcium stearate, or a combination thereof, and wherein the application of the composition causes the soap scum and components of soap scum to disperse or dissolve.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1

### Evaluation of Shower Cleaner Formulations

Applicants designed and tested chemical formulations for enhanced cleaning of showers and other surfaces. In addition, Applicants tested the inventive formulations against several commercially available products, in order to confirm the superiority of Applicants' formulations.

Applicants' methods and formulations were designed to disperse and/or dissolve calcium carbonate and calcium stearate. Additionally, Applicants formulations were designed to achieve dissolving or dispersion of calcium at higher pH values (8-10.5), so that the cleaner can be utilized on all surfaces. Also, Applicants formulations and methods were designed to utilized natural, sustainable reagents and chemicals.

Initial testing of commercially available shower and other household cleaning products was performed. To establish a baseline, the following commercially available products were evaluated: (1) Bar Keepers Friend, (2) Super Shower Cleaner, (3) Multi-surfaces Mr. Clean, (4) Kaboom, (5) Shower, Tub, & Tile, and (6) CLR. All pH values were obtained using a 1 point manually calibrated pH meter.

A. Applicants first evaluated the products to determine the amount of each product needed to dissolve 0.5 g of Calcium Carbonate in 50 mL of deionized water. The following results were obtained:
(1) Bar Keeper's Friend: No observable change after 20 mL of product. This result may be due to the product being white slurry.
(2) Super Shower Cleaner: In order to dissolve the calcium carbonate, 30 mL of the product were used.
(3) Multi-surface Mr. Clean: This product did not dissolve calcium carbonate after 30 mLs were used.
(4) Kaboom: 10 mLs of this product dissolved calcium carbonate. The product had an initial pH of 1.10, which indicates that the product cannot be used on all surfaces.
(5) Shower, Tub and Tile: 5 mLs of this product dissolved calcium carbonate. This product had an initial pH of 0.89, which indicates that the product cannot be used on all surfaces.
(6) CLR: 3 mLs of this product dissolved calcium carbonate. This product had an initial pH of 2.6, which indicates that the product cannot be used on all surfaces.

B. Applicants next evaluated the products to determine the amount of each product needed to dissolve 0.5 g of Calcium Stearate on the surface of 50 mL of deionized water. The following results were obtained:
1. Bar Keeper's Friend: No observable change after 20 mL of product. This result may be due to the product being white slurry.
2. Super Shower Cleaner: 30 mL of the product did not dissolve the calcium stearate. The product dispersed the calcium stearate.
3. Multi-surface Mr. Clean: 30 mL of the product did not dissolve the calcium stearate. The product dispersed the calcium stearate.
4. Kaboom: 30 mL of the product did not dissolve the calcium stearate. The product dispersed the calcium stearate.
5. Shower, Tub and Tile: 30 mL of the product did not dissolve the calcium stearate. The product dispersed the calcium stearate.
6. CLR: 30 mL of the product did not dissolve the calcium stearate. The product dispersed the calcium stearate.

C. Applicants evaluated the products to observe 0.1 grams of Calcium Stearate to 2.1 grams of the following compounds in 100 mLs of deionized water:
1. Anhydrous Citric Acid: No observable effects.
2. Ethylenediaminetetracetic Acid (EDTA): No observable effects.
3. Nitrilotriacetic Acid (NTA): No observable effects.
4. EDTA Tetrasodium Salt Dihydrate: No observable effects.
5. NTA Trisodium Salt: No observable effects.
6. Jarfactant 225DK: Disperses it well.
7. Sodium Dodecyl Sulfate: Disperses it well.
8. Itaconix Dispersant DSP 2K: Disperses it well.
9. Itaconix DSP 2K: When adjusted to a pH of 8.0 with Caustic Soda (50 wt. % sodium hydroxide), there was no effect.
10. Jeecol CA-20: No observable effects.
11. Sodium 3-(1-Pyridinio)-1-propanesulfonide: No observable effects.
12. Sodium Metasilicate: No observable effects.
13. IGEPAL CO-520: No observable effects.
14. Carboxymethyl Cellulose sodium salt: No observable effects.

### Example 2

### Preparation and Testing of New Cleaning Formulation

A. Solution #1

The following was added to 100 mL of Deionized water: 2 grams of Jarfactant 225DK (Dispersant) and 1 gram of Itaconix D2K (calcium binding agent). The pH of Solution #1 was adjusted to 10.7 with caustic soda (50 wt. % sodium hydroxide).

Solution #1 was tested for ability to dissolve calcium stearate and calcium carbonate. Solution #1 was able to dissolve 100 mg of calcium stearate. Solution #1 dissolved 100 mg of calcium carbonate.

B. Solution #2

To Solution #1, 100 mg of NTA Trisodium Salt was added to make Solution #2. The pH of Solution #2 was adjusted to 10.7 with caustic soda (50 wt. % sodium hydroxide).

Solution #2 was tested for ability to dissolve calcium stearate. Solution #2 partially dissolved 100 mg of calcium stearate.

Solution #2 was tested for ability to dissolve calcium carbonate. Solution #2 did not dissolve 100 mg of calcium carbonate.

C. Solution #3:

Solution #1 was altered by the addition of 10 mL of Sodium Xylene Sulfonate to make Solution #3. The pH of Solution #3 was adjusted to 10.7 with caustic soda (50 wt. % sodium hydroxide).

Solution #3 was tested for ability to dissolve 100 mg of calcium stearate. Solution #3 did not dissolve 100 mg of calcium stearate.

Solution #3 was tested for ability to dissolve calcium carbonate. Solution #3 did not dissolve 100 mg of calcium carbonate.

D. Solution #4

Solution #1 was altered by the addition of 1.1 grams of sodium carboxymethyl cellulose. The pH of Solution #1 was adjusted to pH to 10.7 with caustic soda (50 wt. % sodium hydroxide).

Solution #4 was tested for ability to dissolve 100 mg of calcium stearate. Solution #4 dissolved 100 mg of calcium stearate.

Solution #4 was tested for ability to dissolve calcium carbonate. Solution #4 dissolved 100 mg of calcium carbonate.

### Example 3

### Increase in Binding Capacity Studied by Turbidity Measurements

A method to test solution formula performance is the anti-precipitation test. Higher turbidity values typically indicate a decrease in solubility of the test compound (calcium stearate or calcium carbonate) and a decrease in solution formula performance. Base Solutions A through E were prepared and then tested for anti-precipitation of calcium carbonate and calcium stearate using a LaMotte turbidity meter (Laboratory Turbidity & Chlorine Meter LaMotte LTC3000we LaMotte 1972-EPA). The instrument reads turbidity from 0-4,000 NTU. The instrument was calibrated with 0, 1, and 10 NTU standards. All samples were tested using the base solutions as a blank.

### Preparation of Solutions:

Base Solution A: 450 mL of deionized water, 5 grams of Jarfactant 225DK (Dispersant), and 5 grams of Itaconix D2K (calcium binding agent). The pH of Base Solution A was adjusted to pH to 10.7 with caustic soda (50 wt. % sodium hydroxide).

Base Solution B: 450 mL of deionized water, 5 grams of Jarfactant 225DK (Dispersant), 5 grams of Itaconix D2K (calcium binding agent) and 5 grams of Sodium carboxymethyl cellulose (dispersion aid). The pH of Base Solution B was adjusted to pH to 10.7 with caustic soda (50 wt. % sodium hydroxide).

Base Solution C: 450 mL of deionized water, 5 grams of Jarfactant 225DK (Dispersant), 5 grams of Itaconix D2K (calcium binding agent) and 0.100 g of sodium 3-(1-Pyridinio)-1-propanesulfonide (dispersion aid). The pH of Base Solution C was adjusted to pH to 10.7 with caustic soda (50 wt. % sodium hydroxide).

Base Solution D: 450 mL of deionized water, 5 grams of Jarfactant 225DK (Dispersant), 5 grams of Itaconix D2K (calcium binding agent), and 10 grams of Sodium carboxymethyl cellulose (dispersion aid). The pH of Base Solution D was adjusted to pH to 10.7 with caustic soda (50 wt. % sodium hydroxide).

Base Solution E: 450 mL of deionized water, 5 grams of Jarfactant 225DK (Dispersant), 5 grams of Itaconix D2K (calcium binding agent), 10 grams of Sodium carboxymethyl cellulose (dispersion aid) and 0.8 grams of anhydrous sodium silicate (builder). The pH of Base Solution E was adjusted to pH to 10.7 with caustic soda (50 wt. % sodium hydroxide).

### Results:

Base Solutions A through E were tested for anti-precipitation of calcium carbonate and calcium stearate using a LaMotte turbidity meter.

Table 1 shows turbidity values obtained from 10 mLs of Base Solution A containing 10 to 60 mg of calcium stearate or 10 to 20 mg of calcium carbonate. Turbidity increases from 0.51 NTU to 26.2 NTU with the addition of 10 to 60 mg of calcium stearate, respectively. At 50 mg of calcium stearate the Turbidity values were inconsistent. Turbidity increases from 16 NTU to 62.3 NTU with the addition of 10 to 20 mg of calcium carbonate, respectively.

TABLE 1
Turbidity Measurements of Base Solution A.

| Turbidity (NTU) | Calcium Stearate (mg) | Calcium Carbonate (mg) |
|---|---|---|
| 0.51 (16.2)¹ | 10 | 10 |
| 6.71 (62.3)¹ | 20 | 20 |
| 11.7 | 30 | — |
| 10.24 | 40 | — |
| 0.51, 2.00, 4.00² | 50 | — |
| 26.2 | 60 | — |

¹Turbidity values obtained using calcium carbonate values are in parenthesis.
²Inconstant values obtained at 50 mg of Calcium Stearate.

Table 2 shows turbidity values obtained from 10 mLs of Base Solution B containing 10 to 60 mg of calcium stearate or 10 to 50 mg of calcium carbonate. Solution B was prepared to test the effects of Sodium carboxymethyl cellulose as dispersion aid. Table 2 shows, with the exception of 60 mg of Calcium Stearate, a decrease in turbidity for calcium stearate compared to Base Solution A. At 20 mg of calcium carbonate 26 NTU was obtained. This value was lower compared to the turbidity value obtained from Base solution B. Sodium carboxymethyl cellulose was shown to be an effective dispersion aid for the solution.

TABLE 2
Turbidity Measurements of Base Solution B.

| Turbidity (NTU) | Calcium Stearate (mg) | Calcium Carbonate (mg) |
|---|---|---|
| 1.25 (18.2)¹ | 10 | 10 |
| 1.27 (26.0)¹ | 20 | 20 |
| 3.74 (21.7)¹ | 30 | 30 |
| 7.13 (36.0)¹ | 40 | 40 |
| 9.93 (70.9)¹ | 50 | 50 |
| 28.5 | 60 | — |

¹Turbidity values obtained using calcium carbonate values are in parenthesis.

Base Solution C was tested with 50 mg of calcium stearate and 40.2 NTU was obtained. The value is much higher than Base Solution B. Sodium 3-(1-Pyridinio)-1-propanesulfonide was shown not to be an effective dispersion aid for the solution.

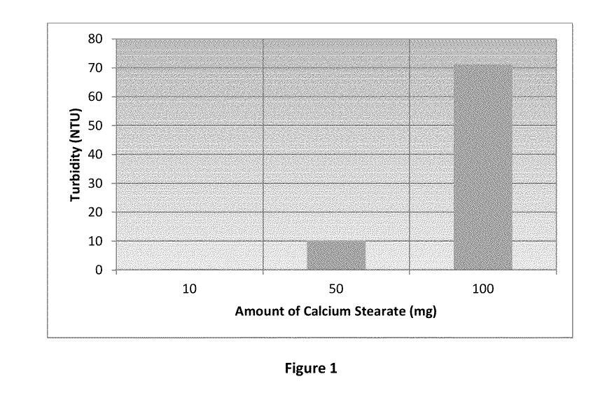

FIG. 1 illustrates turbidity values of 0.41, 10.16, and 71.1 from Base Solution D with the addition of 10, 50, and 100 mg of calcium stearate, respectively. When compared to results for Base Solution B (shown in Table 2 above), the additional 5 g of Sodium carboxymethyl cellulose in Base Solution D had little effect on turbidity values obtained from calcium stearate. 50 mg of calcium carbonate resulted in 105.5 NTU, which is an increase from 70.9.

Base Solution E was prepared to test the effect of sodium silicate as a builder. Results showed an exceptionally low turbidity (33.1 NTU) for calcium carbonate. When 0.8 grams of sodium silicate was added to Base Solution B the turbidity increased to 105.4 NTU.

### Example 4

### Increase in Binding Capacity Studied by Turbidity Measurements

A method to test solution formula performance is the anti-precipitation test. Higher turbidity values typically indicate a decrease in solubility of the test compound (calcium stearate) and a decrease in solution formula performance. Base Solution F was prepared and then tested for anti-precipitation of calcium stearate using a LaMotte turbidity meter (Laboratory Turbidity & Chlorine Meter LaMotte LTC3000we LaMotte 1972-EPA). The instrument reads turbidity from 0-4,000 NTU. Thirteen commercially available household cleaners (both “green” and non-green), designated for the purpose of this experiment as Cleaners A-M, were tested for anti-precipitation of calcium stearate using a LaMotte turbidity meter. The instrument was calibrated with 0, 1, and 10 NTU standards. All samples were tested using the base solutions as a blank.

Base Solution F: 450 mL of deionized water, 10 grams of Jarfactant 225DK, and 10 grams of Itaconix D2K, 8.5 grams of sodium gluconate; 4 grams of EGM, 2.9 grams of NaOH to pH 10.7, 2.0 grams Citric acid to pH 8.5, 0.25 mL BON, 0.2 mL Ocean Mist. Final pH of base solution F is 7.5-9.0.

### Results:

Base Solution F was tested for anti-precipitation of calcium stearate using a LaMotte turbidity meter. Thirteen commercially available household cleaners (both “green” and non-green), designated for the purpose of this experiment as Cleaners A-M, were tested for anti-precipitation of calcium stearate using a LaMotte turbidity meter.

Table 3 shows turbidity values obtained from 10 mLs of Base Solution F and Cleaners A through M following addition of calcium stearate and stirring for a specific amount of time.

TABLE 3
Turbidity Values (NTU) for Cleaners mixed with Calcium Stearate

| Cleaner | Turbidity |
|---|---|
| Base Solution F | 22.7 |
| Cleaner A | 725 |
| Cleaner B | 695 |
| Cleaner C | 115 |
| Cleaner D | 281 |
| Cleaner E | 1150 |
| Cleaner F | 122 |
| Cleaner G | 695 |
| Cleaner H | 2620 |
| Cleaner I | 239 |
| Cleaner J | 103.8 |
| Cleaner K | 75.6 |
| Cleaner L | 10.3 |
| Cleaner M | 84.3 |

These formulations may be prepared by conventional procedures well known in the art. It will be appreciated that the above compositions may be varied according to well-known techniques to accommodate differing amounts and types of active ingredient ‘Compound X’. Aerosol formulation (vi) may be used in conjunction with a standard aerosol dispenser. Additionally, the specific ingredients and proportions are for illustrative purposes. Ingredients or reagents may be exchanged for suitable equivalents and proportions may be varied, according to the desired properties of the form of interest or use.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A composition for cleaning surfaces, comprising an effective amount of the following: one or more calcium chelating agents, one or more nonionic surfactants, one or more anionic polymeric surfactants, an acid, and water, wherein the pH of the composition is adjusted with an amount of an alkaline material to about 7.0 and 10.0.

2. The composition of claim 1, wherein the composition comprises one calcium chelating agent, and wherein the calcium chelating agent is an itaconic acid polymer.

3. The composition of claim 2, wherein the calcium chelating agent is Itaconix D2K.

4. The composition of claim 1, wherein the amount of calcium chelating agent comprises between about 0.05% to about 15% (w/w) of the composition.

5. The composition of claim 1, wherein the composition comprises one nonionic surfactant, and wherein the nonionic surfactant is an alkyl polyglucoside, alkyl polysaccharide, or an alkoxylated alcohol.

6. The composition of claim 5, wherein the nonionic surfactant is Jarfactant 225.

7. The composition of claim 1, wherein the amount of nonionic surfactant comprises between about 0.05% to about 15% (w/w) of the composition.

8. The composition of claim 1, wherein the composition comprises one or more anionic polymeric surfactants.

9. The composition of claim 1, wherein the anionic polymeric surfactant comprises between about 0.5% to about 25% (w/w) of the composition.

10. The composition of claim 1, further comprising one or more chelating agents.

11. The composition of claim 10, wherein the composition comprises one chelating agent.

12. The composition of claim 11, wherein the chelating agent is sodium gluconate.

13. The composition of claim 12, wherein the amount of chelating agent comprises between about 0.01% to about 15.0% (w/w) of the composition.

14. The composition of claim 1, further comprising at least one from the group comprising: a fragrance, a dye, an odor neutralizer, a preservative, a coloring agent, a biocide, a bactericide, an antifungal agent, a thickener, and a germicide.

15. The composition of claim 1, wherein the composition is biodegradable.

16. The composition of claim 1, wherein the composition is created from sustainable or renewable reagents.

17. The composition of claim 1, wherein the composition is non-toxic.

18. The composition of claim 1, wherein the alkaline material is sodium hydroxide.

19. A method of cleaning surfaces, comprising applying an effective amount of the composition of claim 1, to a surface, wherein the top of the surface contains iron oxide, calcium carbonate or calcium stearate deposits, or a combination thereof, and wherein the application of the composition causes the iron oxide, calcium stearate, or calcium carbonate deposits, or the combination thereof, to disperse or dissolve.

20. A composition for cleaning surfaces, comprising an effective amount of the following: one or more calcium chelating agents, one or more nonionic surfactants, one or more chelating agents, one or more anionic polymeric surfactants, an acid, an odor neutralizer, a fragrance, and water, wherein the pH of the composition is adjusted with an amount of an alkaline material to about 7.0 and 10.0, wherein the composition is environmentally safe.
